(19) United States
(12) Patent Application Publication
(10) Pub. No.: US 2017/0253496 A1
(43) Pub. Date: Sep. 7, 2017

(54) Method for Separating Water from a Mixture Containing Water and At Least One Volatile Acid and/or Basic Substance

(71) Applicant: Siemens Aktiengesellschaft, Muenchen (DE)

(72) Inventors: Thomas Hammer, Hemhofen (DE); Markus Ziegmann, Baiersdorf (DE)

(73) Assignee: Siemens Aktiengesellschaft, Muenchen (DE)

(21) Appl. No.: 15/507,022

(22) PCT Filed: May 11, 2015
(86) PCT No.: PCT/EP2015/060332

§ 371 Date: Feb. 27, 2017

(30) Foreign Application Priority Data
Aug. 29, 2014 (DE) 10 2014 217 281.0

(51) Int. Cl. C02F 1/04; C02F 1/66; C02F 1/16

(52) U.S. Cl. CPC C02F 1/048; C02F 1/16; C02F 1/66; C02F 2101/16

(57) ABSTRACT

A method for separating water from a mixture containing water and at least one volatile acidic substance and/or at least one volatile basic substance may include converting the at least one volatile acidic substance into the corresponding non-volatile basic substance by an acid-base reaction and/or converting the at least one basic substance into the corresponding non-volatile acidic substance, and separating the water from the at least one non-volatile acidic substance and/or the at least one non-volatile basic substance.

### CROSS-REFERENCE TO RELATED APPLICATIONS

This application is a U.S. National Stage Application of International Application No. PCT/EP2015/060332 filed May 11, 2015, which designates the United States of America, and claims priority to DE Application No. 10 2014 217 281.0 filed August 29, 2014, the contents of which are hereby incorporated by reference in their entirety.

### TECHNICAL FIELD

The invention relates to a method for separating water from a mixture containing water and at least one volatile acidic substance and/or at least one volatile basic substance.

### BACKGROUND

Methods for separating water from mixtures containing water and acidic or basic substances are of great importance in water treatment, for example in the case of so-called waste water or process water generated in many branches of industry.

The thermal separation or treatment of water from a corresponding mixture in which the acidic or basic substances have physiochemical properties similar to that of the water to be separated is particularly challenging. This applies in particular to volatile acidic or basic substances, i.e. typical volatile acids or bases.

The conventional approaches used to date, particularly distillation or rectification processes, for separating water from corresponding mixtures need to be improved, because as a rule, such approaches are complex and inefficient from the standpoints of both process and plant engineering.

### SUMMARY

One embodiment provides a method for separating water from a mixture containing water and at least one volatile acidic substance and/or at least one volatile basic substance, the method comprising the following steps: converting the at least one volatile acidic substance into the corresponding non-volatile basic substance by means of an acid-base reaction and/or converting the at least one basic substance into the corresponding non-volatile acidic substance, and separating the water from the at least one non-volatile acidic substance and/or the at least one non-volatile basic substance.

In one embodiment, separation of the water from the at least one non-volatile acidic substance and/or the at least one non-volatile basic substance is carried out thermally.

In one embodiment, separation of the water from the at least one non-volatile acidic substance and/or the at least one non-volatile basic substance takes place by means of at least one evaporation process in which the water is converted to a gaseous state, or by means of at least one vaporization process in which the water is converted to a gaseous state.

In one embodiment, the water converted to a gaseous state by means of the evaporation process or the vaporization process is reconverted to a liquid state by means of at least one condensation process.

In one embodiment, at least one volatile acidic substance and/or at least one volatile basic substance is used which, based on a specified pressure, particularly atmospheric pressure, and a specified temperature, particularly a temperature of 25° C., has a boiling point in the range of the boiling point of water and/or a vapor pressure in the range of the vapor pressure of water.

In one embodiment, the acid-base reaction for converting the at least one volatile acidic substance into the corresponding non-volatile basic substance is carried out at a pH above the pKs value of the volatile acidic substance, and/or the acid-base reaction for converting the at least one volatile basic substance into the corresponding non-volatile acidic substance is carried out at a pH below the pKs value of the volatile basic substance.

In one embodiment, the mixture is adjusted to a pH required for carrying out the respective acid-base reaction by the addition of at least one additional acidic substance and/or the addition of at least one additional basic substance.

In one embodiment, the addition of the at least one additional acidic substance and/or the addition of the at least one additional basic substance is/are carried out depending on the pH of the mixture.

In one embodiment, the pH of the mixture and/or at least one parameter of the mixture correlated therewith, particularly electrical conductivity, are determined before and/or after addition of the at least one additional acidic substance and/or the at least one additional basic substance.

In one embodiment, the at least one additional acidic substance to be added and/or the at least one additional basic substance to be added is/are added in an excess dosage.

In one embodiment, a respectively corresponding non-volatile substance in the form of a salt is formed and supplied to at least one, particularly industrial, tertiary process using said salt.

In one embodiment, the proportional composition of the mixture is determined.

In one embodiment, peracetic acid is used as a volatile acidic substance and ammonia is used as a volatile basic substance.

Another embodiment provides a device for carrying out the method disclosed above, wherein the device comprises at least one apparatus, particularly a reactor, for converting at least one volatile acidic substance into the corresponding non-volatile basic substance by means of an acid-base reaction and/or for converting at least one volatile basic substance into the corresponding non-volatile acidic substance by means of an acid-base reaction, and at least one apparatus, particularly a reactor, for separating the water from the at least one non-volatile acidic substance and/or the at least one non-volatile basic substance.

### BRIEF DESCRIPTION OF THE DRAWINGS

Example aspects and embodiments of the invention are described below with reference to the drawings, in which:

FIG. 1 is a schematic diagram of an example device for carrying out a method for separating water from a mixture containing water and at least one volatile acidic substance and/or at least one volatile basic substance, according to an embodiment of the invention; and

FIG. 2 is a schematic diagram of a process for separating water, e.g., for the method shown in FIG. 1, including a condensation stage carried out in a condensation device and a vaporization process carried out in a vaporization device configured parallel thereto, according to an embodiment of the invention.

### DETAILED DESCRIPTION

Embodiments of the invention provide an improved method for separating water from a mixture containing water and at least one volatile acidic substance and/or at least one volatile basic substance.

Some embodiments provide a method comprising the following steps:
converting the at least one volatile acidic substance into the corresponding non-volatile basic substance by means of an acid-base reaction and/or converting the at least one basic substance into the corresponding non-volatile acidic substance, and
separating the water from the at least one non-volatile acidic substance and/or the at least one non-volatile basic substance.

Embodiments of the method constitute a special technical approach for separating water from a mixture containing water and at least one volatile acidic substance or at least one volatile basic substance. The method can therefore be referred to or considered to be a process for water treatment or be implemented in a process for water treatment.

In the following, volatile acidic substances or volatile basic substances are to be understood in particular as referring to acids and/or bases whose physiochemical properties are similar to those of water. In particular, volatile acidic substances or volatile basic substances are to be understood as acids and/or bases which, based on a specified pressure, particularly atmospheric pressure, and a specified temperature, particularly a temperature of 25° C., i.e. typically under standard conditions, have a boiling point in the area of the boiling point of water and/or a vapor pressure in the area of the vapor pressure of water. This applies for example to peracetic acid, which can therefore be used as a corresponding volatile acidic substance, and to ammonia, which can therefore be used as a corresponding volatile basic substance.

In particular, the corresponding mixture containing water and at least one volatile acidic substance or at least one volatile basic substance can be waste water from at least one industrial process such as wet aseptic filling, in which rinse water mixed with peracetic acid is produced, or water vapor production, in which boiler feed water mixed with ammonia is produced.

In a first step of the method, the respective volatile acidic substances are converted by means of an acid-base reaction to the non-volatile basic substance conjugated or corresponding thereto. Similarly, respective volatile basic substances are converted by means of an acid-base reaction to the non-volatile acid substance conjugated or corresponding thereto. Typically, therefore, volatile acids are converted in an acid-base conversion reaction to their respectively corresponding bases and volatile bases are converted in an acid-base conversion reaction to their respectively corresponding acids. It is of essential importance in this case that the corresponding basic or acidic substances show physicochemical properties differing from the volatile acidic or basic substances, and in particular, the former should not be volatile.

As an example, this principle will now be explained in further detail with respect to volatile acidic substances. Of course, the same also applies to volatile basic substances.

Without addition of the pH-modifying substances and with correspondingly low acidity, the volatile acidic substances are originally present in the mixture, particularly when it is at physicochemical equilibrium, at least largely in their undissociated form. The volatile acidic substances contained in the mixture, or the majority thereof, have not yet donated the proton( ) or hydrogen cation(s) that are generally characteristic of the acidic properties of acids, at least according to the definition of Bronsted, for which reason, as mentioned above, they are originally present in the non-dissociated form.

In the non-dissociated state, the volatile acidic substances show covalent bonding properties, i.e. the chemical elements responsible for the acidic nature of the substances are largely covalently bonded. The respective volatile acidic substances show a relatively weak external charge, which is essentially limited to dipole effects attributable to the differing electronegativities of the chemical elements making up the respective acidic substances.

Conversion of the volatile acidic substances to their respectively corresponding non-volatile basic substances causes their physicochemical properties to change significantly. Conversion of the volatile acidic substances to their corresponding non-volatile basic substances is carried out, as mentioned above, by means of an acid-base reaction and results in dissociation, i.e. the donation of protons. The corresponding non-volatile basic substances are ionic in nature because of donation of the proton or protons. The corresponding non-volatile basic substances no show a relatively strong external charge. The corresponding non-volatile substances can therefore be more strongly hydrated. The hydration shells that form around the corresponding non-volatile basic substances by corresponding hydration processes make these substances significantly less volatile, particularly compared to their corresponding volatile acidic substances.

In connection with the first process step with respect to the respective acid-base reaction to be carried out for convert in the respective volatile acidic substances or basic substances to respectively corresponding non-volatile basic substances or acidic substances, one must therefore be careful to select suitable reaction partners and suitable process parameters, i.e. particularly pH, temperature, pressure etc., in order to achieve as complete conversion as possible of the volatile acidic substances or basic substances originally contained in the mixture into the respectively corresponding non-volatile basic substances or acidic substances.

In a second step of the method, the water is separated from the non-volatile acidic substance(s) or the non-volatile basic substance(s). In general, all process can be used for separation of the water that make it possible to carry out single or multistage separation of the water from a corresponding mixture containing water and non-volatile acidic or basic substances. Preferably, separation of the water from the non-volatile acidic substance(s) or the non-volatile basic substance(s) is carried out thermally. The method can therefore be referred to as or considered to be a method for the thermal separation of water from a mixture containing water and at least one volatile acidic substance and/or at least one volatile basic substance. Basically, of course, it is also possible to separate the non-volatile acidic substance(s) or non-volatile basic substance(s) from the water.

In connection with separation of the water, for example, it is possible to allow separation of the water from the at least one non-volatile acidic substance and/or the at least one non-volatile basic substance to take place by means of at least one evaporation process in which the water is converted to a gaseous state, or by means of at least one vaporization process in which the water is converted to a gaseous state. In the process of separating the water from the respective non-volatile acidic or basic substances, therefore, one makes use of the physicochemical properties, which now differ, i.e. particularly the differing volatility, said properties making it possible, by selecting suitable process parameters, particularly temperature and pressure, to convert only the relatively volatile water to a gaseous state and thus separate it from the non-volatile acidic or basic substances. The residual non-volatile acidic or basic substances can be concentrated in a concentrate or a concentrate flow.

Depending on the temperature or pressure level at which separating of the water is carried out, said separation can be carried out by means of at least one evaporation process (above the boiling point of the water at a respective pressure level) or at least one vaporization process (below the boiling point of the water at a respective pressure level). Separation by means of at least one vaporization process is a particularly advantageous and efficient principle from an energetic standpoint.

As mentioned above, separation of the water is generally carried out thermally, i.e. the method is preferably a process for the thermal separation of water from a mixture containing water and at least one volatile acidic substance and/or at least one volatile basic substance.

The water converted to a gaseous state by means of the at least one evaporation process or by means of the at least one vaporization process water can further be recondensed by means of at least one condensation process and thus converted back to a liquid state. Correspondingly, the at least one evaporation process or the at least one vaporization process can take place in a process comprising at least one evaporation stage or at least one vaporization process as well as at least one condensation stage parallel to the at least one condensation process in which the water converted to a gaseous state is (re)condensed. Such processes are known, for example, by names such as “multistage flash distillation,” abbreviated MSF, or multi-effect distillation,” abbreviated as MED. However, a process is also known according to water contained in a fluid mixture is separated from the fluid mixture by vaporization processes and subsequently recondensed.

The respective acid-base reaction for converting the at least one volatile acidic substance into the corresponding non-volatile basic substance is advantageously carried out at a pH above the pKs value of the volatile acidic substance. Similarly, the respective acid-base reaction for converting the at least one volatile basic substance to the corresponding non-volatile acidic substance is advantageously carried out at a pH below the pKs value of the volatile basic substance. Basically, the pH of the (original) mixture determines whether the volatile acidic substances or volatile basic substances contained therein are in dissociated or non-dissociated form. The pH of the mixture therefore constitutes an essential parameter for adjusting or shifting the equilibrium of the respective acid-base reaction, in which the respective volatile acidic substances or the respective volatile basic substances are converted to the respectively corresponding non-volatile basic substances or non-volatile acidic substances, in the direction of the respective non-volatile basic substances or acidic substances.

The mixture is therefore preferably adjusted to a pH that is required or suitable for carrying out the respective acid-base reaction, i.e. for shifting the equilibrium of the acid-base reaction in the direction of the respective non-volatile basic substances or acidic substances by adding or dosing of at least one additional acidic substance or acid and/or by adding or dosing at least one additional basic substance or base.

By adjusting the pH of the acid-base reaction for the conversion of a volatile acidic substance to the corresponding non-volatile basic substance to a pH above the pKs value of the volatile acidic substance, the equilibrium of the acid-base reaction is shifted to a significant degree in the direction of the non-volatile basic substance corresponding thereto. Typically, the pH should be adjusted to a level at least one pH unit above the pKs value of the volatile acidic substance. Adjusting i.e. in this case increasing, the pH is typically carried out by adding preferably strong bases such as potassium hydroxide or sodium hydroxide. In the case of a mixture of volatile acidic substances having differing pKs values, the pH should be selected such that it is above the pKs value of the volatile acidic substance with the highest pKs value. In this way, it can be ensured that all of the volatile acidic substances contained in the mixture dissociate and are converted in accordance with their respectively corresponding non-volatile basic substances.

Similarly, the equilibrium of the acid-base reaction is significantly shifted, by setting the pH of the acid-base reaction for converting a volatile basic substance into the corresponding non-volatile acidic substance at a level below the pKs value of the volatile basic substance, in the direction of the corresponding non-volatile acidic substance. Typically, the pH in this case as well should be adjusted to a level at least one pH unit below the pKs value of the volatile basic substance. Adjusting, i.e. in this case increasing, the pH is typically carried out by adding preferably strong acids such as hydrochloric acid or sulfuric acid.

In the case of a mixture of volatile basic substances with differing pKs values, the pH should be selected such that it is below the pKs value of the volatile basic substance with the lowest pKs value. In this manner, it can be ensured that all of the volatile basic substances contained in the mixture are converted to their respectively corresponding non-volatile acidic substances.

It should be mentioned here that the proportional chemical composition of the mixture should preferably be determined in order to be able to recognize a mixture of a plurality of volatile acidic or basic substances, which optionally have differing pKs values. For this purpose, for example, spectroscopic tests, particularly UV/VIS spectroscopic tests, can be carried out on the mixture. It is also conceivable to determine specified parameters depending on the proportional chemical composition of the mixture, such as electrical conductivity, and optionally to draw conclusions as to proportional chemical composition of the mixture by comparing said parameters with reference values.

It can seen from the above that the desired acid-base reaction for the conversion of volatile acidic substances to respectively corresponding non-volatile basic substances can be controlled or regulated by the addition of at least one base, thus increasing the pH of the mixture. Similarly, the desired acid-base reaction for converting volatile basic substances to respectively corresponding non-volatile acidic substances can be controlled or regulated by the addition of at least one acid, thus reducing the pH. Of course, it is also possible to (additionally) influence the respective acid-base reaction or the equilibrium thereof by means of further process parameters, i.e. particularly temperature and pressure.

The addition or dosing of the at least one additional acid and/or the addition or dosing of the at least one additional base is advantageously carried out depending on the (original) pH of the mixture. The original pH of the mixture should therefore be directly or indirectly determined by means of suitable tests, i.e. using at least one parameter that is correlatable or correlated with the pH of the mixture, such as electrical conductivity.

It is therefore advantageous to determine the pH of the mixture and/or at least one parameter of the mixture that is correlatable or correlated therewith, preferably electrical conductivity, and preferably continuously. Determination of the pH and/or the at least one parameter correlated therewith can be carried out before and/or after addition of the at least one additional acid and/or the at least one additional base. In all cases, adjustment or control of the addition of additional acids and/or bases is carried out depending on a respective determination result involving the pH of the mixture.

Provided that pH or a parameter correlating therewith is determined only before or after the addition of the additional acids or base, it can generally be determined which proportion or added concentration of the additional acids or bases is required to adjust the mixture to a desired pH. By determining the pH or a parameter correlated therewith before and after the addition of additional acids or bases, the pH of the mixture can be adjusted in more precise fashion, as one can determine what effect the addition of the additional acid(s) or base(s) actually had on the pH of the mixture, so that it is optionally possible to modify or adapt said addition, either proportionally or with respect to concentration.

The at least one additional acid that has been or is to be added and/or the at least one additional base that has been or is to be added can be added in an excess dosage.

In this manner, it is optionally possible by means of the excess dosage to recycle volatile acidic or basic substances not converted in the acid-base reaction by means of a circular process and to use them in a subsequent acid-base reaction for the conversion of corresponding volatile acidic or basic substances to their corresponding non-volatile basic or acidic substances. Moreover, this excess dosage also make it possible to ensure a certain pH of the mixture, which as mentioned above is of essential importance for the desired conversion of corresponding volatile acidic or basic substances to their respectively corresponding non-volatile basic or acidic substances.

Beginning from an excess dosage, it is also possible to interrupt the addition of extra acids or bases immediately before discharging a concentrate flow. Discharging of the concentrate flow can be carried out at a pH that is one unit above or below the pKs value of the respective acidic or basic substances. After discharging, further acids or bases can again be added to restore the excess dosage level. Within the framework of the respective acid-base reactions for the conversion of volatile acidic or basic substances to the respectively corresponding non-volatile basic or acidic substances, salts may be formed. The salts typically contained in a corresponding concentrate flow can be used in a variety of ways. It is preferably provided that a respectively corresponding non-volatile substance is formed as a salt and supplied to at least one preferably industrial tertiary process using said salt. In this connection, purely by way of example, one can mention the sodium acetate formed in neutralization of acetic acid with a sodium hydroxide solution, which can be industrially or economically applied as a salt for addition to foods or as a phase change material.

Other embodiments provide a device for carrying out the method described. The device comprises at least one apparatus, particularly a reactor, for converting at least one volatile acidic substance to the corresponding or conjugated non-volatile basic substance by means of an acid-base reaction and/or for converting at least one volatile basic substance into the corresponding non-volatile acidic substance by means of an acid-base reaction, and at least one apparatus, particularly a reactor, for separating the water from the at least one non-volatile acidic substance and/or the at least one non-volatile basic substance. The former and/or the latter apparatus can be integrated into a water treatment plant.

All explanations concerning the method apply analogously to the device.

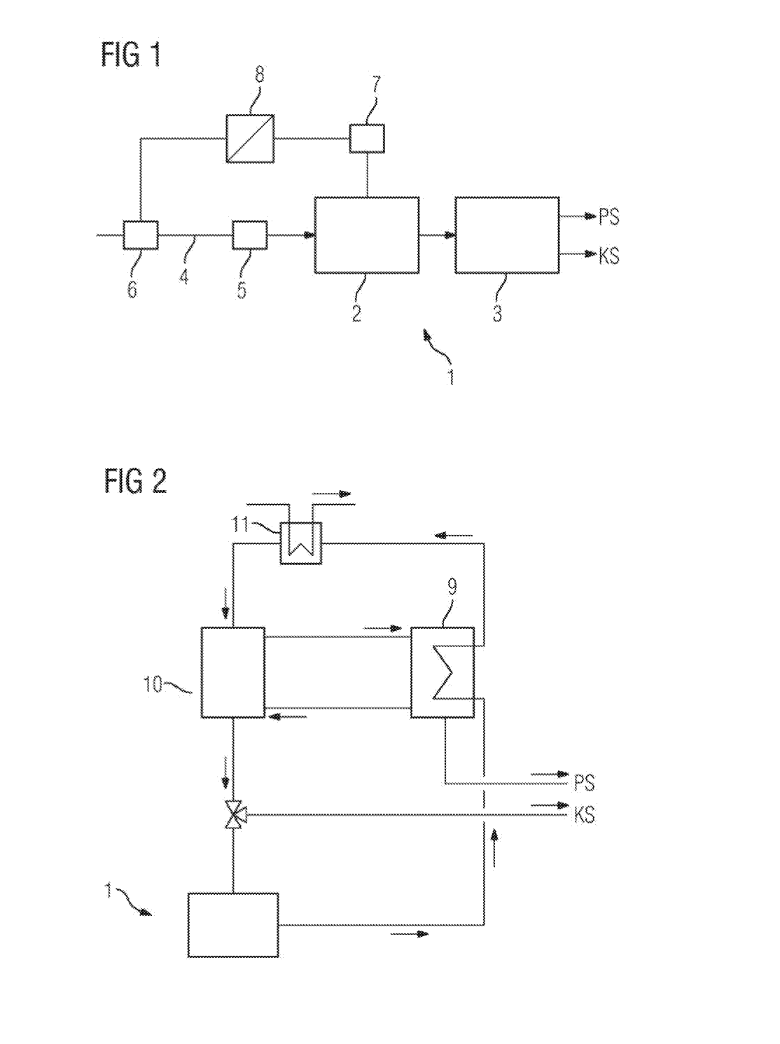

FIG. 1 is a schematic diagram of a device 1 for carrying out a method for separating water from a mixture containing water and at least one volatile acidic substance, typically an acid, and/or at least one volatile basic substance, typically a base, according to an embodiment of the invention.

Accordingly, the method that can be carried out by means of the device 1 is used for the treatment of aqueous mixtures or aqueous solutions containing acids or bases. Both acidic and basic aqueous mixtures can be prepared by means of the device 1.

In particular, the mixture can be an acidic aqueous solution, produced for example in wet aseptic filling, which essentially contains an acid, particularly peracetic acid, and water, or a basic aqueous solution, generated for example in water vapor production and referred to as boiler feed water, which essentially contains a base, particularly ammonia, and water.

The device 1 comprises an apparatus 2 or a reactor for converting at least one volatile acidic substance to the corresponding or conjugated non-volatile basic substance by means of an acid-base reaction or for converting at least one volatile basic substance into the corresponding non-volatile acidic substance. The device 1 further comprises an apparatus 3 or a reactor for separating the water from the previously formed non-volatile acidic or basic substances. As can be seen further below in connection with FIG. 2, at least the apparatus 3 can be part of a process for the treatment of water comprising at least one evaporation stage or at least one vaporization stage, as well as least one condensation stage.

The method that can be or is carried out with the device 1 will first be explained based on an acidic aqueous solution to be prepared that contains a volatile acidic substance, in the present case peracetic acid (CH₃COOOH), and water.

In a first step of the method, the volatile acidic substance is converted by means of an acid-base reaction to the non-volatile basic substance conjugated or corresponding thereto. The volatile acidic substance is originally present in the mixture largely in its undissociated form. The majority of the peracetic acid molecules have not yet donated the proton or hydrogen cation characteristic of the acidic properties.

In the non-dissociated state, the volatile acidic substance is of a covalent nature. The volatile acidic substance shows a relatively weak external charge or partial charge, which is essentially limited to dipole effects attributable to the differing electronegativities of the chemical elements composing it. The volatility of the volatile acidic substance is essentially determined by this.

By conversion of the volatile acidic substance into the corresponding non-volatile basic substance, the physicochemical properties change significantly. Conversion of the volatile acidic substance into the corresponding non-volatile basic substance (CH₃COOO⁻) takes place by means of the acid-base reaction presented below and causes dissociation of the volatile acidic substance, i.e. the donation of protons:

CH₃COOOH+H₂O [symbol] CH₃COOO⁻+H₃O⁺

The non-volatile basic substance (CH₃COOO⁻) corresponding to the volatile acidic substance is ionic in nature. Accordingly, the non-volatile basic substance now shows a relatively strong external charge. The non-volatile basic substance can therefore be more strongly hydrated. The hydration shell forming due to hydration processes around the non-volatile basic substance makes it much less volatile, particularly compared to its corresponding volatile acidic substance.

Starting from a basic aqueous solution to be prepared, and thus from a mixture containing a volatile basic substance, in the present case ammonia (NH₃), and water, the volatile basic substance is analogously converted by means of an acid-base reaction into the conjugated or corresponding non-volatile acidic substance.

The volatile basic substance is originally present in the mixture in its non-protonated form. A majority of the ammonia molecules have originally not undergone the proton acceptance characteristic of the basic properties.

In the non-protonated state, the volatile basic substance has covalent bonding properties. The volatile basic substance therefore shows a relatively weak charge or partial charge, which is also essentially limited to dipole effects attributable to the differing electronegativities of the chemical elements composing. This essentially determines the volatility of the volatile basic substance.

By conversion of the volatile basic substance into the corresponding non-volatile acidic substance, the physicochemical properties change significantly. Conversion of the volatile basic substance into the corresponding non-volatile acidic substance (NH4+) takes place by means of the acid-base reaction presented below and involves protonation of the base, i.e. the uptake of protons:

NH₃+H₂O [symbol] NH₄⁺+OH⁺

In this case as well, the non-volatile acidic substance (NH₄⁺) corresponding to the volatile basic substance is ionic in nature. Accordingly, the non-volatile acidic substance now shows a relatively strong external charge. The non-volatile acidic substance can therefore be more strongly hydrated. The hydration shell forming around the non-volatile acidic substance due to hydration processes makes the substance much less volatile, particularly compared to its corresponding volatile basic substance (NH³).

In connection with the first process step with respect to the respective acid-base reaction to be carried out for converting the respective volatile acidic substances or basic substances to respectively corresponding non-volatile basic substances or acidic substances, one must be careful to select suitable reaction partners and suitable process parameters, i.e. particularly pH, temperature, pressure etc., in order to achieve as complete conversion as possible of the volatile acidic substances or basic substances originally contained in the mixture into the respectively corresponding non-volatile basic substances or acidic substances.

In a second step of the method, the water is separated from the respective non-volatile acidic or basic substance. The separated water is discharged from the apparatus 3 in a product flow PS, and the non-volatile acidic or basic substances are discharged in a concentrate flow PS. In general, all processes can be used for separation of the water that allow single or multistage separation of the water from the corresponding mixture containing water and non-volatile acidic or basic substances. Separation of the water from the mixture is preferably carried out thermally. A particular process is described below in greater detail with reference to FIG. 2.

The respective acid-base reaction to convert volatile acidic substances into the corresponding non-volatile basic substances is carried out at a pH of the mixture above the pKs value of the volatile acidic substances. Similarly, the respective acid-base reaction to convert volatile basic substances into the corresponding non-volatile acidic substances is carried out at a pH of the mixture below the pKs value of the volatile basic substances. The mixture is therefore adjusted to a pH required for carrying out the respective acid-base reaction by dosing of at least one additional acid, such as hydrochloric acid, or by dosing of at least one additional base, such as sodium hydroxide. The dosing of additional acids or bases is carried out by means of a dosing device 5 configured in a supply line 4 leading to the apparatus 2.

By adjusting the pH of the mixture, the equilibrium of the acid-base reaction can be shifted in the direction of the respective non-volatile acidic or basic substances. The pH is typically adjusted by converting a volatile acidic substance to the corresponding non-volatile basic substance at a pH at least one unit above the pKs value of the volatile acidic substance. Accordingly, the pH in conversion of a volatile basic substance to the corresponding non-volatile acidic substance is adjusted to a level at least one pH unit below the pKs value of the volatile basic substance.

The pKs value of the volatile peracetic acid is approx. 8.2, so the acid-base reaction for converting said peracetic acid to the corresponding non-volatile basic substance should be carried out at a pH of at least 9.2. As mentioned above, the pH is adjusted, i.e. increased in this case, by selective dosing of a base such as sodium hydroxide.

The pKs value of the volatile ammonia is approx. 9.2, so the acid-base reaction for converting said ammonia to the corresponding non-volatile acidic substance should be carried out at a maximum pH of 8. As mentioned above, the pH is adjusted, i.e. reduced in this case, by selective dosing of an acid such as hydrochloric acid.

It is possible for a mixture to contain a plurality of volatile acidic or basic substances with optionally differing pKs values. For this reason, the proportional chemical composition of the mixture should be determined. For this purpose, for example, spectroscopic tests, particularly UV/VIS spectroscopic tests, can be carried out on the mixture. It is also possible to determine certain parameters depending on the proportional chemical composition of the mixture, such as electrical conductivity, and optionally to draw conclusions as to the proportional chemical composition of the mixture by comparing said parameters with reference values.

Possible dosing of additional acids or bases by means of the dosing device 5 may preferably be carried out depending on the pH. In this case, the pH of the mixture is directly or indirectly determined, typically in a continuous manner, by means of suitable pH measurement devices 6, 7, i.e. using at least one parameter of the mixture that is correlatable or correlated with pH, such as electrical conductivity.

As can be seen in FIG. 1, a first pH measurement device 6 is configured upstream of the dosing device 5. A second pH measurement device 7 is configured downstream of the dosing device 5. Accordingly, the pH of the mixture can be determined before and after the dosing of additional acids or additional bases. Dosing can be precisely controlled or regulated by means of a control unit 8 associated with the pH measurement device 6, 7 and the dosing device 5.

Additional acids or bases to be added may be added in an excess dosage. The excess dosage is particularly advantageous s in that unconverted volatile acidic or basic substances can e.g. be recycled in a circular process to a subsequent acid-base reaction and be used for the conversion of corresponding volatile acidic or basic substances. Moreover, this excess dosage also make it possible to ensure a certain pH of the mixture, which is of essential importance for the desired conversion of volatile acidic or basic substances to their respectively corresponding non-volatile basic or acidic substances.

Based on an excess dosage, it is also possible to discontinue the supply of additional acids or bases immediately before discharging a concentrate flow. Discharging of the concentrate flow can be carried out at a pH one unit above or below the pKs value of the respective acidic or basic substances. After discharging, the supply of additional acids or bases can be resumed and the excess dosage restored.

The reaction salts formed in the respective acid-base reactions can, contained in the concentrate flow KS, can be supplied to a preferably industrial tertiary process using said salts.

A special process for separating the water according to the second process step will be briefly discussed below with reference to FIG. 2. The process comprises a condensation stage carried out in a condensation device 9 and a vaporization process carried out in a vaporization device 10 configured parallel thereto.

The water to be separated from the non-volatile acidic or basic substances (raw water) is fed from the device 1 implemented in the process through the condensation device 9, in which it absorbs heat during the condensation taking place under the conditions prevailing there and thus serves as a cooling medium.

The heated water is then further heated by an external heat source 11, typically a heat exchanger, by means of which waste heat from industrial processes can be transferred to the water, and fed into the vaporization device 10 from above. In the vaporization device 10, the water is passed over a suitable vaporizing material.

The temperature of the water flowing downstream in the vaporization device 10 decreases from the head to the foot, as heat is withdrawn from the water by vaporization and heat transfer to the air flowing in the opposite direction. Accordingly, the temperature of the air flowing in the opposite direction increases from the foot to the head of the vaporization device 10. However, in stable operation under stationary conditions, the temperature of the air always remains below the water temperature in the same area of the vaporization device 10. Heat transfer from the falling water to the rising air therefore takes place in the vaporization device 10. As it temperature increases, the air can take up more water vapor. The water and air therefore constitute a countercurrent heat exchanger.

After passing through the vaporization device 9, the concentrated water is cooled and supplied to a storage tank, which is not shown. Cooling can also be carried out downstream of such a storage tank. pH can be adjusted in such a storage tank. In order to prevent an excessively high concentration, a portion of the concentrated water can be replaced by fresh raw water.

In a loss-free case, the heat output to be dissipated by cooling is equal to the thermal energy supplied less the energy required for demixing (change in entropy). From an energy standpoint, the process is particularly efficient.

Although the invention has been illustrated and described in further detail based on the preferred embodiment, it is by no means limited by the disclosed examples, and other variations can be derived by the person skilled in the art without departing from the scope of protection of the invention.

What is claimed is:

1. A method for separating water from a mixture containing water and at least one of (a) at least one volatile acidic substance or (b) at least one volatile basic substance, the method comprising:
performing a conversion process including at least one of:
converting the at least one volatile acidic substance into the corresponding non-volatile basic substance by an acid-base reaction, or
converting the at least one basic substance into the corresponding non-volatile acidic substance, and
performing a water separation process including separating the water from the at least one of (a) the at least one non-volatile acidic substance or (b) the at least one non-volatile basic substance.

2. The method of claim 1, wherein the water separation process is performed thermally.

3. The method of claim 1, wherein the water separation process includes at least one evaporation process in which the water is converted to a gaseous state, or at least one vaporization process in which the water is converted to a gaseous state.

4. The method of claim 3, comprising performing at least one condensation process to reconvert the water converted to a gaseous state by the evaporation process or the vaporization process to a liquid state.

5. The method of claim 1, wherein at least one volatile acidic substance and/or at least one volatile basic substance is used which, based on a specified pressure, particularly atmospheric pressure, and a specified temperature, particularly a temperature of 25° C., has a boiling point in the range of the boiling point of water and/or a vapor pressure in the range of the vapor pressure of water.

6. The method of claim 1, wherein:
the acid-base reaction for converting the at least one volatile acidic substance into the corresponding non-volatile basic substance is performed at a pH above the pKs value of the volatile acidic substance,
the acid-base reaction for converting the at least one volatile basic substance into the corresponding non-volatile acidic substance is performed at a pH below the pKs value of the volatile basic substance.

7. The method of claim 6, comprising adjusting the mixture to a specified pH for performing the respective acid-base reaction by adding an additional substance, wherein the addition substance comprises at least one of (a) at least one additional acidic substance or (b) at least one additional basic substance.

8. The method of claim 7, wherein adding the additional substance is performed depending on the pH of the mixture.

9. The method of claim 7, wherein at least one of (a) the pH of the mixture or (b) at least one parameter of the mixture correlated with the pH of the mixture is/are determined at least one of before or after adding the additional substance.

10. The method of claim 7, comprising adding the additional substance in an excess dosage.

11. The method of claim 1, comprising forming a corresponding non-volatile substance in the form of a salt and supplying the salt to an industrial tertiary process using said salt.

12. The method of claim 1, comprising determining a proportional composition of the mixture.

13. The method of claim 1, comprising using peracetic as a volatile acidic substance and using ammonia as a volatile basic substance.

14. A device for separating water from a mixture containing water and at least one volatile acidic substance and/or at least one volatile basic substance, the device comprising:
a conversion reactor, configured to perform a conversion process including at least one of: (a) convert at least one volatile acidic substance into the corresponding non-volatile basic substance by an acid-base reaction or (b) convert at least one volatile basic substance into the corresponding non-volatile acidic substance by means of an acid-base reaction, and
a separation reactor configured to perform a water separation process including separate the water from the at least one of the (a) at least one non-volatile acidic substance or (b) at least one non-volatile basic substance.
